(19) United States
(12) Patent Application Publication
(10) Pub. No.: US 2012/0251046 A1
(43) Pub. Date: Oct. 4, 2012

(54) OPTICAL WAVEGUIDE CIRCUIT

(75) Inventors: Hiroshi Kawashima, Tokyo (JP); Kazutaka Nara, Tokyo (JP)

(73) Assignee: Furukawa Electric Co., Ltd., Tokyo (JP)

(21) Appl. No.: 13/445,360

(22) Filed: Apr. 12, 2012

Related U.S. Application Data
(63) Continuation of application No. PCT/JP11/05386, filed on Sep. 26, 2011.

(30) Foreign Application Priority Data
Sep. 24, 2010 (JP) 2010-214064

(51) Int. Cl. G02B 6/34; G02B 6/26; G02B 6/10; G02B 6/00

(52) U.S. Cl. 385/37; 385/141; 385/15; 427/163.2

(57) ABSTRACT

The present invention provides an optical waveguide circuit which includes: a waveguide made of a material whose temperature coefficient of refractive index has a second-order component; a groove formed in a part of the waveguide; and a compensation material having a temperature coefficient of refractive index different from the temperature coefficient of refractive index of the waveguide, and in which a normal line of an interface between the groove and the waveguide, and an optical axis of light propagating through the waveguide intersect at a predetermined intersection angle, and the predetermined intersection angle is determined so as to reduce a second-order component of optical path length change of the waveguide due to the second-order component of temperature coefficient of the refractive index of the waveguide.

### CROSS-REFERENCES TO RELATED APPLICATIONS

This application is a continuation application of International Application No. PCT/JP2011/005386, filed Sep. 26, 2011, which claims the benefit of Japanese Patent Application No. 2010-214064, filed Sep. 24, 2010. The contents of the aforementioned applications are incorporated herein by reference in their entireties.

### TECHNICAL FIELD

The present invention relates to an optical waveguide circuit used for an optical communication. More particularly, the present invention relates to an optical waveguide circuit in which temperature dependence is controlled by filling a part of a waveguide which constitutes the optical waveguide circuit with a material having a temperature dependence of refractive index different from that of a material which constitutes the waveguide.

### BACKGROUND ART

A wavelength division multiplexer using a planar lightwave circuit (PLC) has generally the temperature dependence of optical wavelength multiplexing and demultiplexing characteristics. For example, in a Mach-Zehnder interferometer (MZI) with a silica-based PLC made of silica-based glass and the wavelength division multiplexer using an arrayed waveguide gratings (AWG), a temperature coefficient dn(SiO₂)/dT of refractive index of silica-based glass is about 1×10⁻⁵ (11° C.) and a temperature coefficient dλ_{c}/dT of a transmission center wavelength λ_{c} of the wavelength division multiplexer is about 0.01 (nm/° C.).

The patent document 1 discloses a temperature-independent wavelength division multiplexer that has little change of λ_{c} due to temperature by controlling the temperature dependence of λ_{c} of an interferometer as a whole through formation of a groove across an arm waveguide of the MZI and an insertion of a compensation material (resin) having a temperature coefficient of refractive index different from that of the silica-based glass into the groove and, for example, by applying such a compensation material and groove design that compensates the temperature dependence of refractive index of a material constituting an optical interferometer.

The temperature-independence in which the change of the center wavelength λ_{c} along with temperature change is reduced can be achieved by compensating for an optical path length change due to the temperature dependence of refractive index of silica-based glass through the optical path length change due to the temperature dependence of refractive index of the compensation material, by satisfying the following formula:

$$Δ L \cdot \frac{d n ( {SiO}_{2} )}{d T} + Δ L ( resin ) \cdot [ \frac{d n ( resin )}{d T} - \frac{d n ( {SiO}_{2} )}{d T} ] = 0 \qquad ( Formula 1 )$$

wherein, ΔL is a difference in length between two arm waveguides of the MZI, ΔL(resin) is a difference in length between grooves filled with the compensation material (resin) in the two arm waveguides, dn(SiO₂)/dT is the temperature coefficient of refractive index of the silica-based glass, and dn(resin)/dT is the temperature coefficient of refractive index of the compensation material.

However, the temperature dependence of λ_{c} is not completely compensated even in the wavelength division multiplexer as described in the patent document 1.

The temperature coefficient dn(SiO₂)/dT of refractive index of actual silica-based glass waveguide has not only a first-order component but also a second-order component, and can be expressed as follows.

$$\frac{d n ( {SiO}_{2} )}{d T} ≅ 1.9 \times {10}^{- 8} T + 1.0 \times {10}^{- 5} \\ T \text{:} Temperature ( ° C . ) \qquad ( Formula 2 )$$

The wavelength division multiplexer that is made temperature-independent as described in the patent document 1 is designed such that only the first-order temperature dependence is compensated at approximately a center temperature of operating temperature range, and hence the second-order component remains and the temperature dependence slightly remains in entire operating temperature range. FIG. 14 is a graph showing calculation results 1400 of relative center wavelength change due to temperature change when the wavelength division multiplexer is not temperature-compensated, and a calculation result 1401 of relative center wavelength change due to temperature change when only the first-order temperature dependence is compensated at approximately a center temperature of operating temperature range as described in the patent document 1. As shown in the calculation result 1401, a slight temperature dependence remains in entire operating temperature range.

For example, the patent documents 2 and 3 disclose that a multimode waveguide is connected to a slab waveguide of AWG that is made temperature-independent by the conventional method and a field shape (position) of an input light to the slab waveguide is modulated by temperature while exciting a first-order mode. The patent document 4 and non-patent document 1 disclose that in a MZI-synchronized AWG that obtains a flat transmission spectrum and a low loss characteristic through synchronization of frequency characteristics of the AWG and the MZI, a residual temperature dependence is compensated by a method that changes one coupler of optical couplers constituting the MZI to a temperature-dependent phase difference generation coupler in which the phase difference between ports is modulated by temperature.

### CITATION LIST

### Patent Document

Patent document 1: International Publication WO98/36299
Patent document 2: Japanese Patent Application Laid-Open No. 2010-026302
Patent document 3: Japanese Patent Application Laid-Open No. 2010-044350
Patent document 4: Japanese Patent Application Laid-Open No. 2010-044349

### Non Patent Document

Non Patent document 1: Kamei S, et al., Photonics Technology Letters, IEEE, Vol. 21, No. 17, Sep. 1, 2009 p. 1205

### SUMMARY OF INVENTION

Several problems remain in the conventional proposals in terms of compensating the residual temperature dependence. The methods proposed in the patent documents 2 and 3 indicate that the residual temperature dependence is compensated by changing an input light position to the slab waveguide of the AWG. In this case, the methods can not be applied to a wavelength division multiplexer having a circuit configuration other than the AWG such as the MZI, because a configuration specific to the AWG-type wavelength division multiplexer is required in which a transmission wavelength changes depending on the position of the input light. Further, a size is increased by the addition of a multimode waveguide portion and a first-order mode exciting portion.

The methods proposed in the patent document 4 and the non-patent document 1 can be used for compensation of the residual temperature dependence of the MZI-AWG as well as the MZI alone by providing a mechanism that the phase difference between the ports of the optical coupler constituting the MZI changes by temperature. However, there is a need to change at least one of the optical couplers constituting the MZI to the temperature-dependent phase difference generation coupler, which raises a problem in causing an increase in size and loss.

It is an object of the present invention to reduce the second-order component of the optical path length change of the waveguide due to the second-order component of the temperature coefficient of refractive index of the waveguide by using a simple configuration.

The present invention is made for solving above problems and focuses on the optical path length change due to a refraction of propagation light at an interface between the groove filled with the temperature compensation resin and the waveguide.

The present invention provides an optical waveguide circuit comprising a waveguide whose temperature coefficient of refractive index has a second-order component, a groove formed in a part of the waveguide, and a compensation material filled in the groove and having a temperature coefficient of refractive index different from the temperature coefficient of refractive index of the waveguide, wherein a normal line of an interface between the groove and the waveguide, and an optical axis of light propagating through the waveguide intersect at a predetermined intersection angle, and the predetermined intersection angle is determined so as to reduce a second-order component of optical path length change of the waveguide due to the second-order component of the temperature coefficient of the refractive index of the waveguide.

Further, the present invention provides an optical waveguide circuit comprising a plurality of waveguides whose temperature coefficient of refractive index has a second-order component and whose lengths are different from one another, a first groove formed in a first waveguide of the plurality of waveguides, a second groove formed in a second waveguide of the plurality of waveguides, and a compensation material filled in the first and second grooves and having a temperature coefficient of refractive index different from the temperature coefficient of refractive index of the waveguide, wherein a normal line of an interface between the first groove and the first waveguide and an optical axis of light propagating through the first waveguide intersect at a first intersection angle; and a normal line of an interface between the second groove and the second waveguide, and an optical axis of light propagating through the second waveguide intersect at a second intersection angle.

According to the present invention, it enables the optical waveguide circuit to reduce the optical path length change of the waveguide due to the second-order component of the temperature coefficient of refractive index of the waveguide without increasing a size and a loss, and the optical waveguide circuit that is applicable to wide temperature ranges can be obtained. Also it becomes possible to compensate a second-order component of the transmission center wavelength λ_{c} of the wavelength division multiplexer without increasing the size and the loss, and the wavelength division multiplexer that is applicable to wide temperature ranges can be obtained.

### BRIEF DESCRIPTION OF THE DRAWINGS

FIG. 1 is a schematic view showing a waveguide having a groove filled with a temperature compensation resin according to an embodiment of the present invention.

FIG. 2A is a schematic view showing optical path change due to refractive index change along with temperature change according to the embodiment of the present invention, when the refractive index of the waveguide and the refractive index of the temperature compensation resin are equal.

FIG. 2B is a schematic view showing the optical path change due to refractive index change along with temperature change according to the embodiment of the present invention, when the refractive index of the waveguide is larger than the refractive index of the temperature compensation resin.

FIG. 2C is a schematic view showing the optical path change due to refractive index change along with temperature change according to the embodiment of the present invention, when the refractive index of the waveguide is smaller than the refractive index of the temperature compensation resin.

FIG. 3A is a schematic view showing a wavelength division multiplexer according to a first embodiment of the present invention.

FIG. 3B is a schematic view showing the waveguide having the groove filled with the temperature compensation resin according to the first embodiment of the present invention.

FIG. 4A is a diagram showing a calculation result of temperature dependence of a center wavelength λ_{c} according to the first embodiment of the present invention.

FIG. 4B is an enlarged view adjacent to X axis of the calculation result of the temperature dependence of the center wavelength λ_{c} according to the first embodiment of the present invention.

FIG. 5 is a schematic view showing a circuit for a BPM simulation of the wavelength division multiplexer according to the example of the present invention.

FIG. 6 is a diagram showing the temperature dependence of the center wavelength λ_{c} based on the BPM simulation of the wavelength division multiplexer according to the example of the present invention.

FIG. 7A is a diagram showing a calculation result of the temperature dependence of the center wavelength λ_{c} of a wavelength division multiplexer according to a second embodiment of the present invention.

FIG. 7B is an enlarged view adjacent to X axis of the calculation result of the temperature dependence of the center wavelength λ_{c} of the wavelength division multiplexer according to the second embodiment of the present invention.

FIG. 8 is a schematic view showing a wavelength division multiplexer according to a third embodiment of the present invention.

FIG. 9 is a diagram showing a calculation result of the temperature dependence of the center wavelength λ_{c} of the wavelength division multiplexer according to the third embodiment of the present invention.

FIG. 10 is a schematic view showing a wavelength division multiplexer according to a fourth embodiment of the present invention.

FIG. 11A is a schematic view showing a wavelength division multiplexer according to a fifth embodiment of the present invention.

FIG. 11B is a schematic view showing the wavelength division multiplexer according to the fifth embodiment of the present invention.

FIG. 12 is a schematic view showing a wavelength division multiplexer according to a sixth embodiment of the present invention.

FIG. 13 is a diagram showing a calculation result of the temperature dependence of amount of optical path length change according to the sixth embodiment of the present Invention.

FIG. 14 is a diagram showing a calculation result of the temperature dependence of the center wavelength of a wavelength division multiplexer that is made temperature-independent by the conventional method.

### DESCRIPTION OF EMBODIMENTS

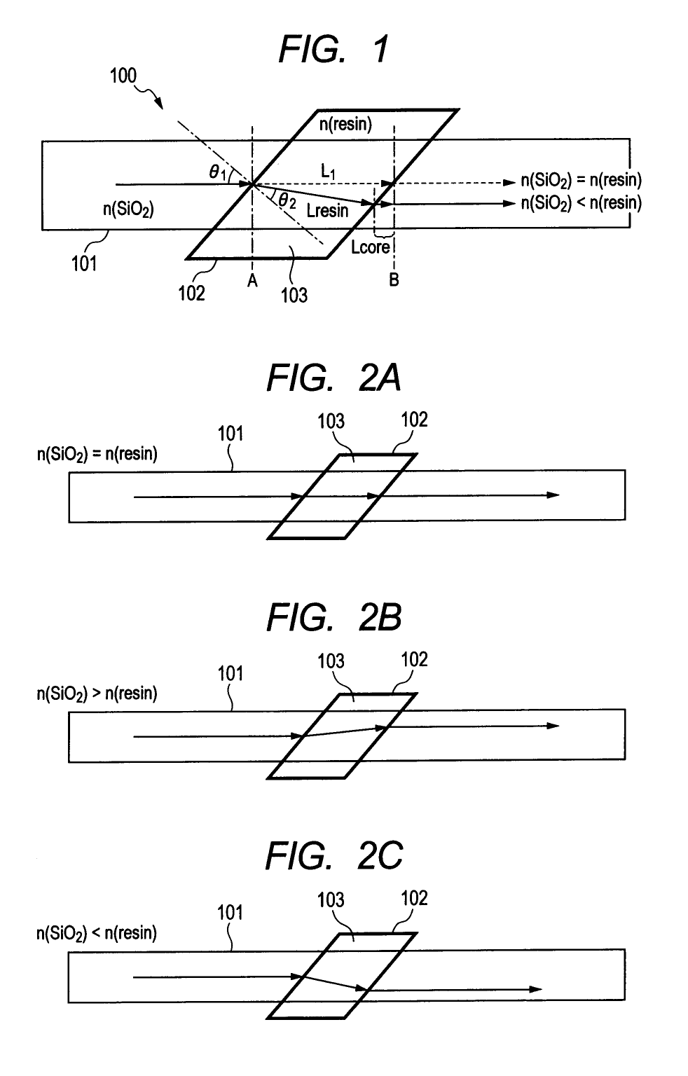

FIG. 1 is a schematic view showing an optical waveguide circuit 100 according to an embodiment of the present invention. The optical waveguide circuit 100 has a waveguide 101 and a groove 102 with a nearly constant width is formed in the waveguide 101, and a temperature compensation resin 103 is filled in the groove 102.

Here, the waveguide includes a core portion and a cladding portion, in the present embodiment and all of the following embodiments. A silica-based glass (SiO₂) as a material for the waveguide and a silicone resin as a material for the temperature compensation resin are used, but the present invention is not limited to the optical waveguide circuit using these materials and may be widely applied to the optical waveguide circuits with the second-order component of the temperature coefficient of refractive index. The groove to be formed in the waveguide can be formed, but is not limited to, by a photolithographic technique using a mask in which the groove is preliminarily incorporated in the waveguide at the design stage or by machining the groove directly on a fabricated waveguide substrate. Also conventional techniques known to those skilled in the art, such as a semiconductor planar technique, may be used for the method of filling the resin in the groove.

In the optical waveguide circuit 100, an intersection angle between the normal line of an interface between the temperature compensation resin 103 and the waveguide 101 and the optical axis of light (a power center of propagation light) propagating through the waveguide 101 is inclined by the intersection angle θ₁. This intersection angle θ₁ allows the compensation of the temperature dependence of the center wavelength λ_{c} of propagation light due to a change in refractive index of the waveguide along with temperature change. More detail will be described below.

The refractive indices of the temperature compensation resin 103 and the waveguide 101 are changed along with temperature change, and thereby a refraction angle θ₂ at an interface between the temperature compensation resin 103 and the waveguide 101 also changes. The refraction angle θ₂ can be expressed by the following Snell's law:

$${θ}_{2} = {sin}^{- 1} ( \frac{n ( {SiO}_{2} )}{n ( resin )} \cdot sin {θ}_{1} ) \qquad ( Formula 3 )$$

For example, when the refractive index n(resin) of the temperature compensation resin and the refractive index n(SiO₂) of the waveguide made of silica-based glass are equal at temperature T₀ and the temperature coefficient of the refractive index dn(resin)/dT of the compensation resin is smaller than the temperature coefficient dn(SiO₂)/dT of refractive index of the waveguide, the refraction angle θ₂ at temperature T becomes large because of the following relation; n(SiO₂)>n(resin) if T>T₀, and the refraction angle θ₂ at temperature T becomes small because of the following relation; n(SiO₂)<n(resin) if T<T₀.

FIGS. 2A to 2C are schematic diagrams showing an optical path change along with refractive index change due to temperature change in the waveguide 101 shown in FIG. 1. When the refractive index n(resin) of the temperature compensation resin 103 and the refractive index n(SiO₂) of the waveguide 101 made of silica-based glass are equal at temperature T₀ and the temperature coefficient dn(resin)/dT of refractive index of the temperature compensation resin 103 is smaller than the temperature coefficient dn(SiO₂)/dT of refractive index of the waveguide 101, the light propagating through the waveguide 101 linearly passes through the temperature compensation resin 103 without refraction at T=T₀ as shown in FIG. 2A. The greater T>T₀, that is, n(SiO₂)>n(resin), the grater the refraction angle θ₂ as shown in FIG. 2B and thereby a distance Lᵣₑₛᵢₙ that is the length of light passing through the resin is increased in length. Also, the smaller T<T₀, that is, n(SiO₂)<n(resin), the smaller the refraction angle θ₂ as shown in FIG. 2C and thereby Lᵣₑₛᵢₙ is decreased in length. Thus, the refractive index change along with temperature change causes the distance that is the length of light passing through the temperature compensation resin 103 to change. At the same time, a geometric propagation distance of the light between A and B as shown in FIG. 1 equals a width L₁ of the groove filled with the temperature compensation resin 103 when n(SiO₂)=n(resin) at temperature T₀, and is the sum of the distance Lᵣₑₛᵢₙ that is the length of light passing through the temperature compensation resin 103 and a distance L_{core} that is the length of light passing through the waveguide 101 from the temperature compensation resin 103 to B, at temperature T. L_{core} also changes due to change in θ₂ along with temperature change.

Lᵣₑₛᵢₙ and L_{core} are expressed by the following formulas using the groove width L₁ along the optical axis of the waveguide shown in FIG. 1.

$$\begin{matrix}L resin = {L}_{1} \cdot \frac{cos {θ}_{1}}{cos {θ}_{2}} & ( Formula 4 ) \\ Lcore = {L}_{1} - {L}_{1} \cdot cos ( {θ}_{1} - {θ}_{2} ) \cdot \frac{cos {θ}_{1}}{cos {θ}_{2}} & ( Formula 5 )\end{matrix}$$

Therefore, the optical path length L_{AB} between A and B shown in FIG. 1 can be expressed by the following formula as a function of the intersection angle θ₁, the refractive index n(resin) of the temperature compensation resin, and the refractive index n(SiO₂) of the waveguide.

$$\begin{matrix}{L}_{AB} = Lresin \cdot n ( resin ) + Lcore \cdot n ( {SiO}_{2} ) \\ = {L}_{1} \cdot \frac{cos {θ}_{1}}{cos {θ}_{2}} \cdot n ( resin ) + \{ \begin{matrix}{L}_{1} - {L}_{1} \cdot \\ cos ( {θ}_{1} - {θ}_{2} ) \cdot \frac{cos {θ}_{1}}{cos {θ}_{2}}\end{matrix} \} \cdot \\ n ( {SiO}_{2} ) \\ = {L}_{1} \cdot \frac{cos {θ}_{1}}{cos \{ {sin}^{- 1} ( \frac{n ( {SiO}_{2} )}{n ( resin )} \cdot sin {θ}_{1} ) \}} \cdot n ( resin ) + \\ \{ \begin{matrix}{L}_{1} - {L}_{1} \cdot cos ( {θ}_{1} - {sin}^{- 1} ( \frac{n ( {SiO}_{2} )}{n ( resin )} \cdot sin {θ}_{1} ) ) \cdot \\ \frac{cos {θ}_{1}}{cos \{ {sin}^{- 1} ( \frac{n ( {SiO}_{2} )}{n ( resin )} \cdot sin {θ}_{1} ) \}}\end{matrix} \} \cdot \\ n ( {SiO}_{2} )\end{matrix} \qquad ( Formula 6 )$$

Since the refractive index n(resin) and the refractive index n(SiO₂) are material-specific parameters, the parameters can not be basically changed when the material is determined, but the intersection angle θ₁ can be arbitrarily changed. Here, since the refractive index n(resin) and the refractive index n(SiO₂) have nonlinearity relative to temperature, the optical path length L_{AB} between A and B is nonlinearly changed relative to temperature but behavior of nonlinear change can be changed depending on the intersection angle θ₁.

Therefore, when the temperature change in the optical path length of the waveguide 101 is constant or is diminished, the intersection angle θ₁ is set such that the optical path length L_{AB} shows behavior of nonlinear change in which the nonlinear refractive index change (that is, the refractive index change including the first-order and second-order components) in the waveguide portion of the waveguide 101 (an unfilled portion of the temperature compensation resin 103) is compensated for or diminished. Thereby the second-order component of the optical path length change due to temperature change in the waveguide 101 can be compensated.

Also, when the waveguide 101 is one of arm waveguides of the wavelength division multiplexer in which the waveguide 101 is the MZI and the like, the second-order component of the optical path length difference due to temperature change between the arm waveguides can be compensated by setting the intersection angle θ₁ such that the optical path length L_{AB} exhibits behavior of nonlinear change that compensates for s or diminishes nonlinear change of refractive index at a portion not filled with the temperature compensation resin 103 (the waveguide portion of the waveguide 101 and the other arm waveguide of the MZI) of the plurality of arm waveguides provided in the MZI.

Accordingly, in the present embodiment, since the optical path length L_{AB} between A and B is changed nonlinearly relative to temperature according to the formula 6, the second-order component of the temperature change of the transmission center wavelength λ_{c} of the wavelength division multiplexer can be compensated by suitably setting the intersection angle θ₁ such that the second-order component of refractive index change of the waveguide is compensated for or diminished. In other words, according to the present embodiment, the optical path length change due to a change of the refractive index of the temperature compensation resin filled in the groove as well as due to a change of propagation pathway depending on refraction of propagation light in the interface between the groove and the waveguide can be controlled.

Further, the present embodiment includes a method for manufacturing the optical waveguide circuit formed by the waveguide made of a material whose temperature coefficient of refractive index has the second-order component, the method comprising the steps of: providing the optical waveguide circuit in which the waveguide is formed; forming a groove in a part of the waveguide; and filling the groove with a compensation material having the temperature coefficient of refractive index different from the temperature coefficient of the refractive index of the waveguide, wherein the normal line of the interface between the groove and the waveguide and the optical axis of light propagating through the waveguide intersect at a predetermined intersection angle, the predetermined intersection angle is determined so as to reduce at least the second-order component of the optical path length change of the waveguide due to the second-order component of the temperature coefficient of the refractive index of the waveguide.

### First Embodiment

In a first embodiment of the present invention, the second-order component of the transmission center wavelength λ_{c} of the wavelength division multiplexer such as the MZI including at least two waveguides is compensated.

In an optical interferometer with the form that interferes with signal light having propagated through the arm waveguide such as the MZI, since characteristics of the transmission center wavelength and the like are determined by an optical path length difference Δ(nL) between the arms, it is not necessary to compensate respective second-order components of the optical path length change in each of the arm waveguides and is enough to set the intersection angle θ₁ of the groove of each waveguide so as to compensate for the second-order component of the optical path length difference Δ(nL) between the arms. Here, since the optical path length change due to refraction at the groove portion of each waveguide is the same direction (as increasing in temperature, Lᵣₑₛᵢₙ becomes longer as shown in FIG. 2b and as decreasing in temperature, Lᵣₑₛᵢₙ becomes shorter as shown in FIG. 2c), the difference of the optical path length change due to refraction at each arm contributes to the change of the optical path length difference Δ(nL) between the arms.

Therefore, in the first embodiment of the present invention, the wavelength division multiplexer such as the MZI including at least two waveguides is directed to keep the optical path length difference between at least two waveguides constant regardless of temperature by incorporating the temperature compensation resin in each waveguide and providing each of the waveguides with the different intersection angle θ₁ of the groove of each waveguide (for example, in the MZI including a first and a second waveguide, a first intersection angle of the first waveguide is set to greater than 0 degree and a second intersection angle of the second waveguide is set to 0 degree) to increase the difference of the optical path length change due to refraction at each arm, and to effectively compensate the temperature dependence of the center wavelength of propagation light due to refractive index change of each waveguide along with temperature change. Also, the temperature compensation resin may be incorporated in only one of at least two waveguides, but as with the present embodiment, the wavelength division multiplexer such as the MZI having small difference of transmission loss of the two waveguides and wide tolerance against manufacturing error can be fabricated by incorporating the temperature compensation resin in all waveguides.

In the present embodiment, more effective compensation can be achieved by appropriately setting each intersection angle θ₁ to the plurality of arms so as to provide the waveguide of the plurality of arms of the MZI with the above-described temperature compensation resin, and to set the intersection angle θ₁ between the waveguides of the arms to a different value, and to compensate for the second-order component of change in the optical path length difference of the optical interferometer due to the refractive index change of the waveguide, that is, to keep the optical path length difference Δ(nL) between the arms constant regardless of temperature.

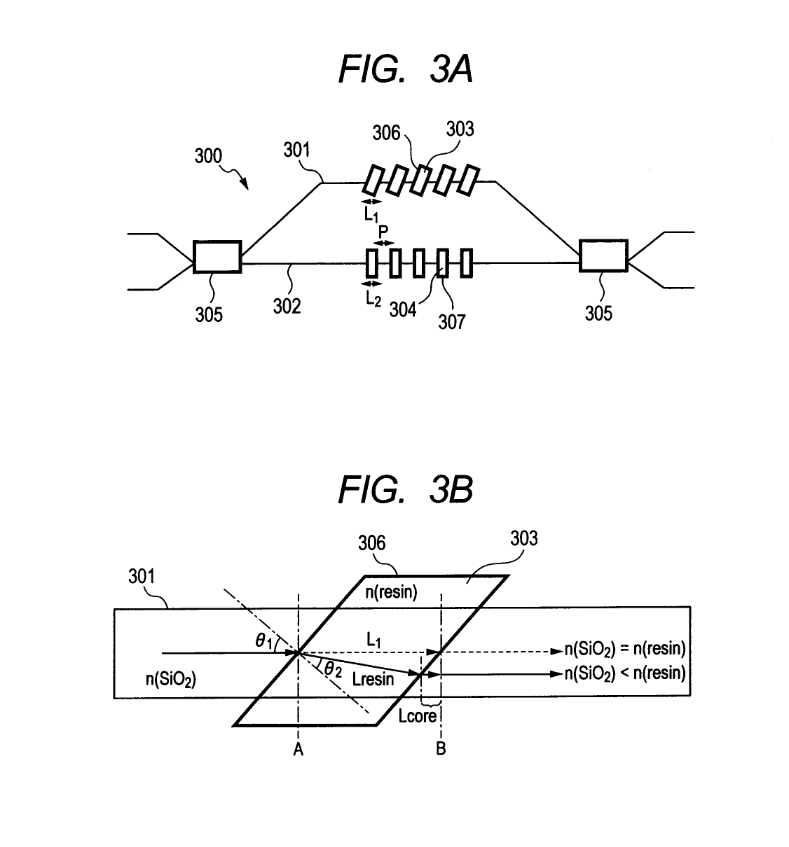

FIG. 3A is a schematic view showing the wavelength division multiplexer according to the first embodiment of the present invention. A wavelength division multiplexer 300 according to the present embodiment is formed as a planar lightwave circuit (PLC) made of silica-based glass formed on a substrate, and includes two 2×2 optical couplers 305 comprising a directional coupler and a Mach-Zehnder interferometer (MZI) having a first arm waveguide 301 and a second arm waveguide 302 that couple those couplers. The first arm waveguide 301 is provided with a first groove 306 formed so as to intersect with the first arm waveguide. A temperature compensation resin (silicone resin) 303 is filled in the first groove. Similarly, the second arm waveguide 302 is provided with a second groove 307 formed so as to intersect with the second arm waveguide. A second temperature compensation resin (silicone resin) 304 is filled in the second groove.

The first arm waveguide 301 is formed to have longer length than that of the second arm waveguide 302 by difference ΔL of the waveguide length. The first and second grooves are equally split into the number of N_{groove} of unit grooves having almost constant width respectively and disposed at a pitch p in the direction of the optical axis of light propagating through each arm waveguide.

As with the waveguide in which the groove filled with the temperature compensation resin is formed shown in FIG. 1, each unit groove of the first groove is formed such that the normal line of the interface between the unit groove of the first groove and the first arm waveguide 301, and the optical axis of light propagating through the first arm waveguide are inclined by intersection angle θ₁ in the horizontal direction relative to the substrate (FIG. 3). On the other hand, each unit groove of the second groove is formed such that the normal line of the interface between the unit groove of the second groove and the second arm waveguide 302, and the optical axis of light propagating through the second arm waveguide coincide in the horizontal direction relative to the substrate (an intersection angle 0 degree).

Groove widths L₁, L₂ along the optical axis of light propagating through each arm waveguide of each unit groove formed in the first arm waveguide 301 and the second arm waveguide 302 respectively are determined so as to satisfy the formula (1) at the temperature near center of operating temperature range, wherein ΔL is the waveguide length difference between two arm waveguides of the MZI before the groove is formed, ΔL(resin)=N_{groove}·(L₁−L₂) is a length difference between two grooves in which arm waveguide is filled with the temperature compensation resin, dn(SiO₂)/dT is the temperature coefficient of refractive index of the waveguide made of silica-based glass which constitutes a core and a cladding, and dn(resin)/dT is the temperature coefficient of refractive index of the temperature compensation resin. The optical path length change due to the temperature dependence of the refractive index of the waveguide is compensated by the optical path length change due to the temperature dependence of the refractive index of the temperature compensation resin, and thereby temperature-independency is achieved at the temperature near center of operating temperature range. Also, not shown in the figure, the first arm waveguide 301 and the second arm waveguide 302 are formed such that the waveguide width becomes thick at an intersection portion with the groove in order to reduce a radiation loss at the groove formed in each arm waveguide and also to facilitate an occurrence of the optical path length change due to refraction.

The temperature dependence of λ_{c} was calculated using parameters shown in Table 1 to confirm the temperature change of the transmission center wave length λ_{c} in the wavelength division multiplexer of the present embodiment.

TABLE 1
MZI parameters for calculation of temperature dependence

| Difference of arm waveguide | 84.27 | μm |
|---|---|---|
| length ΔL | | |
| Coupler coupling factor | 50% | |
| Temperature coefficient of | 1.9 × 10⁻⁸ T + 1.0 × 10⁻⁵ | |
| refractive index of | | |
| waveguide dn(SiO₂)/dT | | |
| Temperature coefficient of | −3.5 × 10⁻⁴ | |
| refractive index of | | |
| temperature compensation | | |
| material dn(resin)/dT | | |
| Difference of groove length | 2.36 | μm |
| ΔL(resin) | | |
| The number of unit grooves | 20 | |
| on each arm N_{groove} | | |
| Unit groove length of a | 10 | μm |
| first groove L₁ | | |
| Unit groove length of a | 9.882 | μm |
| second groove L₂ | | |

The calculation method of the transmission center wavelength λ_{c} is specifically expressed as following steps of:

1. calculating Lᵣₑₛᵢₙ at the predetermined θ₁ and a chip temperature T using the formula (4),
2. calculating L_{core} using the formula (5) as well,
3. calculating a distance difference ΔL(resin)′ that the light propagates through in the temperature compensation resin between both arms using the calculated Lᵣₑₛᵢₙ by means of the formula (7). Wherein, N_{groove} is the number of unit grooves of the arm waveguide.

ΔL(re sin)=(L(re sin)−L₂)·Ngroove (Formula 7)

4. calculating a distance difference ΔL(SiO₂)′ that the light propagates through the waveguide between both arms using the calculated L_{core} by means of the formula (8).

ΔL(SiO₂)′=ΔL−ΔL(re sin)′+Lcore·Ngroove (Formula 8)

5. calculating the optical path length difference Δ(nL) between both arms using ΔL(resin)′ and ΔL(SiO₂)′ and the refractive indices n(resin), n(SiO₂) of the resin and the silica-based glass at temperature T by means of the following formula.

Δ(nL)·n(SiO₂)·ΔL(SiO₂)′+n(re sin)·ΔL(re sin)′ (Formula 9)

6. calculating the transmission center wavelength λ_{c} near a wavelength of 1550 nm using the calculated Δ(nL) and a diffraction order m=79 of a MZI circuit by means of the following formula.

$${λ}_{c} = \frac{Δ ( nL )}{m} \qquad ( Formula 10 )$$

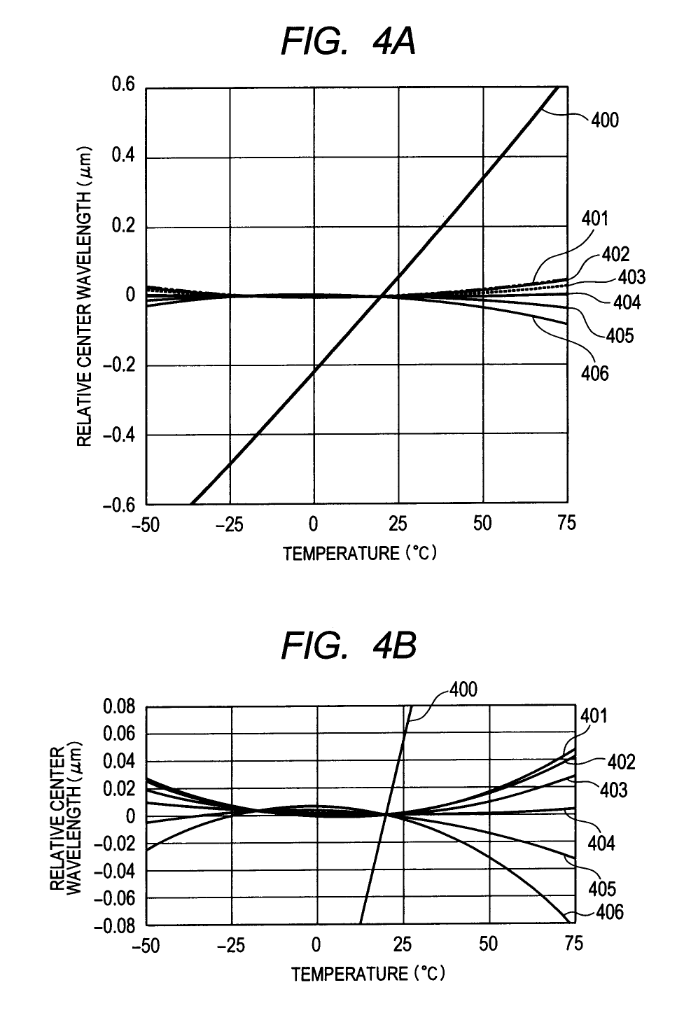

FIG. 4 shows a calculation result of the temperature dependence of the center wavelength λ_{c} obtained by repeating the above steps in the ranges that the intersection angle θ₁ is 0˜25 degrees, and the chip temperature is −50 to +75° C. In FIG. 4, curve lines 401, 402, 403, 404, 405, and 406 show the temperature dependence of the center wavelength λ_{c} respectively at θ₁=5 degrees, θ₁=10 degrees, θ₁=15 degrees, θ₁=20 degrees, and θ₁=25 degrees. Also, the temperature dependence curve line 400 of λ_{c} when the temperature compensation resin is not provided is shown for comparison.

It is understood that the first-order component of the temperature dependence of λ_{c} is compensated by incorporating the temperature compensation resin of the intersection angle θ₁=0 degree in the waveguide, but the second-order component of the temperature dependence of λ_{c} still remains when it is compared to the temperature dependence of λ_{c} of reference numerals 400 and 401 shown in FIGS. 4A and 4B respectively. In addition, it is understood that as the intersection angle θ₁ is increased from 0 degree, the temperature dependence of λ_{c} changes sequentially to downward-convex˜flat˜upward-convex. When the intersection angle is θ₁=0 degree, the center wavelength varies about 0.05 nm in the above temperature range, but the variation of the center wavelength can be suppressed to about 0.01 nm by setting the intersection angle to θ₁≈15 degrees.

When the intersection angle θ₁ obtained by using these steps becomes very large, a groove width L₁ cos θ₁ to be fabricated becomes very small and therefore it is likely to be difficult to form the groove due to fabrication process problems. In this case, it is only necessary to recalculate a feasible groove width by selecting appropriate parameters through enhancing an effect of the optical path length change due to refraction by increasing the number of the unit groove N_{groove}, and also through increasing the unit groove width L₁, L₂, and the like.

Further, the present embodiment includes a method for manufacturing the optical waveguide circuit made by the plurality of waveguides that differ in length and are made of material that a temperature coefficient of refractive index has a second-order component, the method comprising the steps of: providing the optical waveguide circuit in which the plurality of waveguides are formed; forming a first groove in a first waveguide of the plurality of waveguides and a second groove in a second waveguide of the plurality of waveguides; and filling the first and the second grooves with a compensation material having a different temperature coefficient of refractive index from the temperature coefficient of the refractive index of the waveguide, wherein a normal line of an interface between the first groove and the first waveguide and an optical axis of light propagating through the first waveguide intersect at a first intersection angle, and a normal line of an interface between the second groove and the second waveguide and an optical axis of light propagating through the second waveguide intersect at a second intersection angle, the first and the second intersection angles are different, and the first intersection angle is determined such that the second-order component of the temperature change of the optical path length difference between the first and the second waveguides due to the second-order component of the temperature coefficient of the refractive index of the first and the second waveguides are diminished.

### EXAMPLE

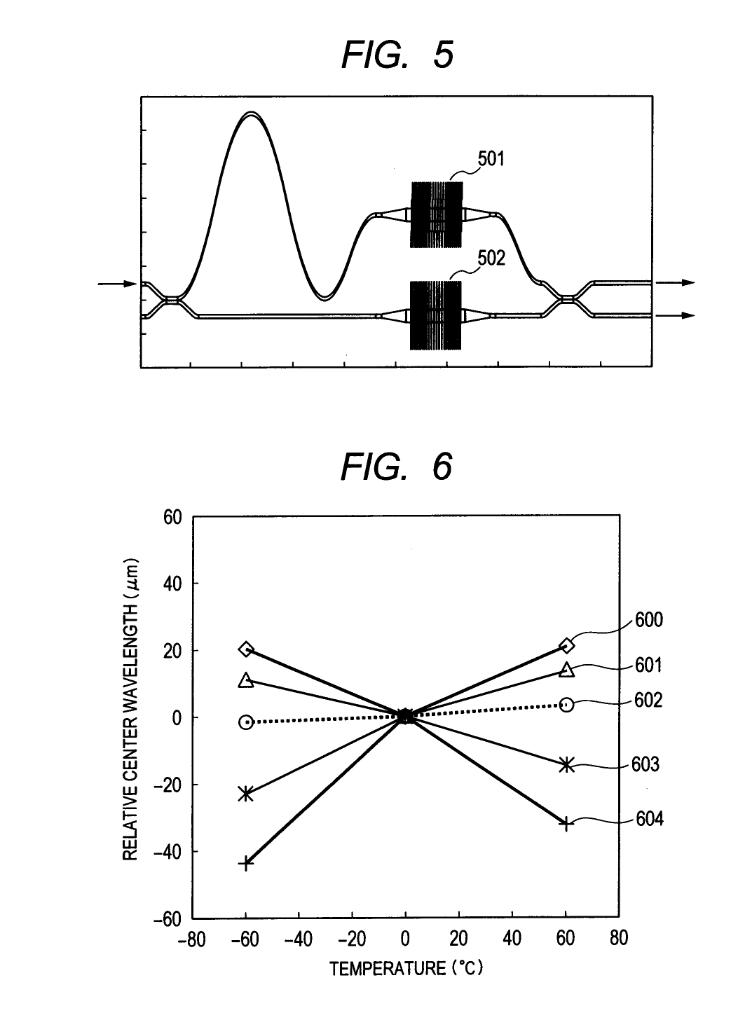

In examples of the present invention, a simulation by means of a beam propagation method was run using a circuit for a BPM simulation of the wavelength division multiplexer as shown in FIG. 5 and parameters in Table 1. The circuit in FIG. 5 includes a groove 501 which is provided so that the intersection angle across an optical axis of light propagating through the first waveguide formed on the first waveguide is inclined by the intersection angle θ₁, and a groove 502 in which the intersection angle θ₁ across an optical axis of light propagating through the second waveguide formed on the second waveguide is 0 degree. FIG. 6 shows the calculation results of the temperature dependence of λ_{c} at the chip temperatures of −60° C., 0° C., +60° C. when the first intersection angle θ₁ is changed in the range of 0 degree to 25 degrees.

FIG. 6 shows temperature dependences of wavelength λc of respectively a curve line 600 at θ₁=0 degree, a curve line 601 at θ₁=8 degrees, a curve line 602 at θ₁=12.5 degrees, a curve line 603 at θ₁=18 degrees, and a curve line 604 at θ₁=22 degrees. From the results shown in FIG. 6, as with FIG. 4, it was confirmed that as the intersection angle θ₁ was increased from 0 degree, the temperature dependence of λ_{c} was changed sequentially to downward-convex-flat-upward-convex, and near flat temperature dependence of λ_{c} was obtained at near θ₁=12.5 degrees.

From the results according to above-described embodiments, it was confirmed that the second-order component of the temperature dependence of λ_{c} can be compensated by the method, which is simple and causes little size increase, comprising an adjustment of the intersection angle θ₁ between the groove that is filled with the temperature compensation resin and the waveguide.

### Second Embodiment

Table 2 shows the MZI parameters of the wavelength division multiplexer according to the second embodiment of the present invention.

TABLE 2
MZI parameters for calculation of temperature
dependence according to the second embodiment

| Difference of arm waveguide | 4040 | μm |
|---|---|---|
| length ΔL | | |
| Coupler coupling factor | 50% | |
| Temperature coefficient of | 1.9 × 10⁻⁸ T + 1.0 × 10⁻⁵ | |
| refractive index of | | |
| waveguide dn(SiO₂)/dT | | |
| Temperature coefficient of | −3.5 × 10⁻⁴ | |
| refractive index of | | |
| temperature compensation | | |
| material dn(resin)/dT | | |
| Difference of groove length | 115 | μm |
| ΔL(resin) | | |
| The number of unit grooves | 60 | |
| on each arm N_{groove} | | |
| Unit groove length of a | 20 | μm |
| first groove L₁ | | |
| Unit groove length of a | 18.08 | μm |
| second groove L₂ | | |

The wavelength division multiplexer according to the present embodiment is almost the same as the wavelength division multiplexer according to the first embodiment and is intended to be applied to a single bit delay device for a receiver used in an optical communication system using a 40 Gbps differential phase shift keying. The wavelength division multiplexer operates to cause the adjacent bits of phase modulated light at 50 Gbps symbol rate be interfered each other and to demodulate the phase modulated signal into an intensity signal. Therefore, an amount of delay is set to 20 ps corresponding to the single bit and the arm waveguide length difference ΔL of the MZI corresponding to this amount of delay is set to 4040 μm. In addition, since ΔL becomes bigger, then the optical path length difference n(SiO₂)·ΔL between the arms to be compensated becomes also bigger, the number of grooves is increased to 60 for enhancing an integral effect of a compensation effect.

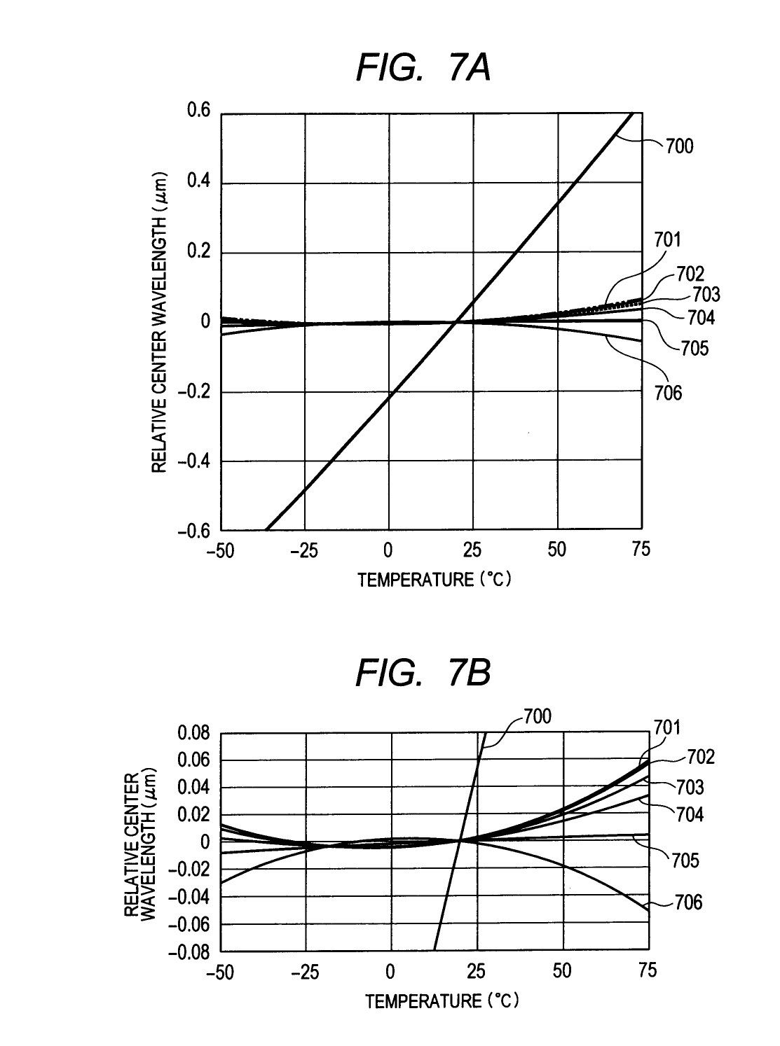

FIG. 7 shows calculation results of the temperature dependence of λ_{c} at the chip temperature of −50° C. to +75° C. when the first intersection angle θ₁ is changed in the range of 0 degree to 50 degrees. FIG. 7B shows an enlarged view adjacent to X axis. FIGS. 7A and 7B show temperature dependences of λ_{c} of respectively a curve line 701 at θ₁=0 degree, a curve line 702 at θ₁=10 degrees, a curve line 703 at θ₁=20 degrees, a curve line 704 at θ₁=30 degrees, a curve line 705 at θ₁=40 degrees and a curve line 706 at θ₁=50 degrees. Also, for comparison, a temperature dependence curve line 700 of λ_{c} when the temperature compensation resin is not provided is shown for comparison.

It is understood that a variation of the center wavelength λ_{c} can be nearly flattened by setting the intersection angle to θ₁=40 degrees from FIGS. 7A and 7B. Thus, it is understood that the wavelength division multiplexer according to a configuration of the present invention is applicable to a wide range of usages for large or small amount of delay of the MZI by appropriately selecting the number of grooves, intersection angles and the like.

### Third Embodiment

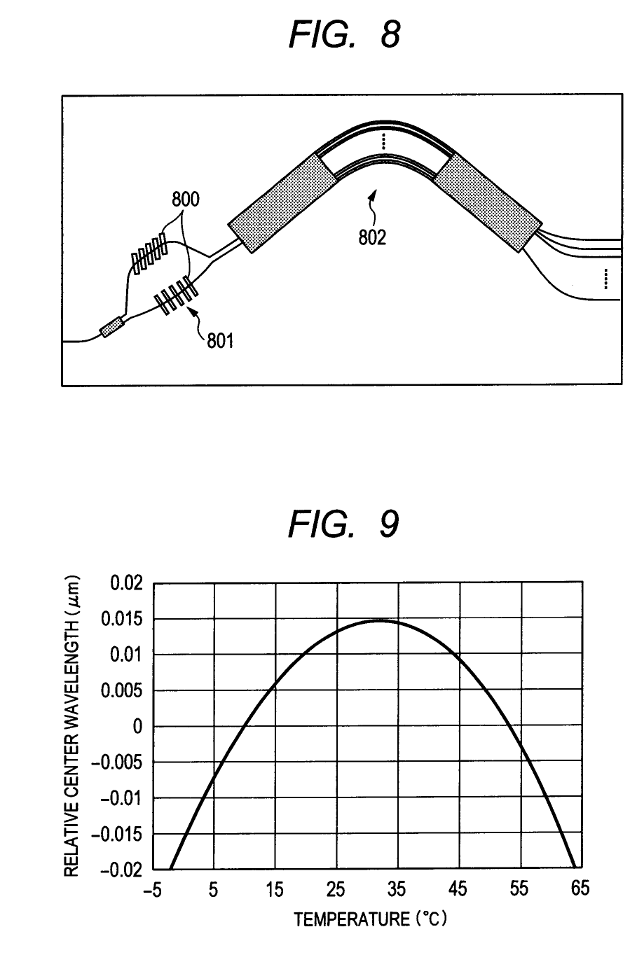

FIG. 8 shows a schematic view of the wavelength division multiplexer according to the third embodiment of the present invention. In FIG. 8, reference numeral 800 indicates the temperature compensation resin filled in the groove, reference numeral 801 indicates the MZI, and reference numeral 802 indicates the AWG. In the wavelength division multiplexer according to the present embodiment, the MZI having parameters shown in Table 3 is applied to a part of the MZI which constitutes a MZI synchronized AWG-type wavelength division multiplexer designed with the same basic design described in the patent document 5.

TABLE 3
MZI parameters for calculation of temperature
dependence according to the third embodiment

| Difference of arm waveguide | 4040 | μm |
|---|---|---|
| length ΔL | | |
| Coupler coupling factor | 50% | |
| Temperature coefficient of | 1.9 × 10⁻⁸ T + 1.0 × 10⁻⁵ | |
| refractive index of | | |
| waveguide dn(SiO₂)/dT | | |
| Temperature coefficient of | −3.5 × 10⁻⁴ | |
| refractive index of | | |
| temperature compensation | | |
| material dn(resin)/dT | | |
| Difference of groove length | 115 | μm |
| ΔL(resin) | | |
| The number of unit grooves | 60 | |
| on each arm N_{groove} | | |
| Unit groove length of a | 20 | μm |
| first groove L₁ | | |
| Unit groove length of a | 18.08 | μm |
| second groove L₂ | | |
| Intersection angle of first | 60 | degrees |
| groove θ₁ | | |

The MZI according to the present embodiment is almost the same wavelength division multiplexer of the second embodiment, but a different point is that the first intersection angle θ₁ is fixed to 60 degrees. FIG. 9 shows calculation results of the temperature dependence of λ_{c} at this MZI chip temperature of −5 to +65° C.

As shown in FIG. 9, the temperature dependence of the MZI center wavelength enabled the compensation of the temperature dependence of the AWG center wavelength and then the temperature-independent characteristics of the MZI synchronized AWG-type wavelength division multiplexer as a whole was able to be obtained.

### Forth Embodiment

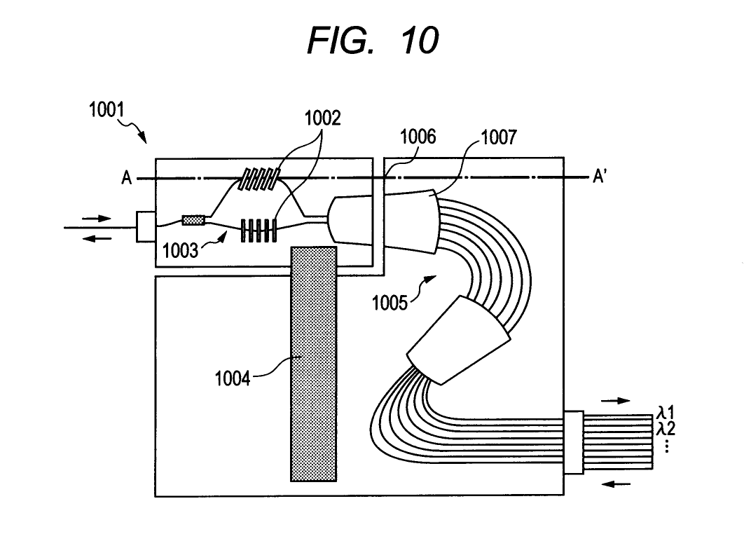

FIG. 10 shows the schematic view of the wavelength division multiplexer according to the forth embodiment. FIG. 10 illustrates a wavelength division multiplexer 1001, a temperature compensation resin 1002 filled in the groove, a MZI 1003, a temperature compensation plate 1004, an AWG 1005, a slab cut section 1006, and an input (output) slab waveguide 1007.

In the present embodiment, a relative location between the MZI chip and the AWG chip is varied in response to operating environmental temperatures and a position of the waveguide is followed by variation of a focus position at the end of the input slab waveguide with changing temperature by separating the input(output) slab waveguide 1006 connected to the MZI 1003 and connecting the MZI chip and the AWG chip with the temperature compensation plate 1004 which stretches in response to operating environmental temperatures. In this case, a technology that reduces the reflection and radiation losses with filling a refractive index matching material between the separated chips may be applied. Also, a module hermetically sealed after immersing the entire chip in the refractive index matching material may be used for assurance reliability of moisture protection of waveguide glass.

The wavelength division multiplexer 1001 of the present embodiment is almost the same as the wavelength division multiplexer according to the third embodiment, but a different point is that the temperature-independence of the AWG is achieved by cutting the input (output) slab waveguide 1006 of the AWG, and utilizing the temperature change of the focal location due to a thermal expansion of the temperature compensation plate 1004.

In addition, since the temperature-independent AWG applied to the wavelength division multiplexer 1001 of the present embodiment has the second-order component of the center wavelength temperature dependence caused by the second-order component of the temperature coefficient of the refractive index of silica-based glass, the second-order component of the center wavelength temperature dependence as a whole is able to be compensated for by compensating the MZI temperature dependence with the same method as the third embodiment.

### Fifth Embodiment

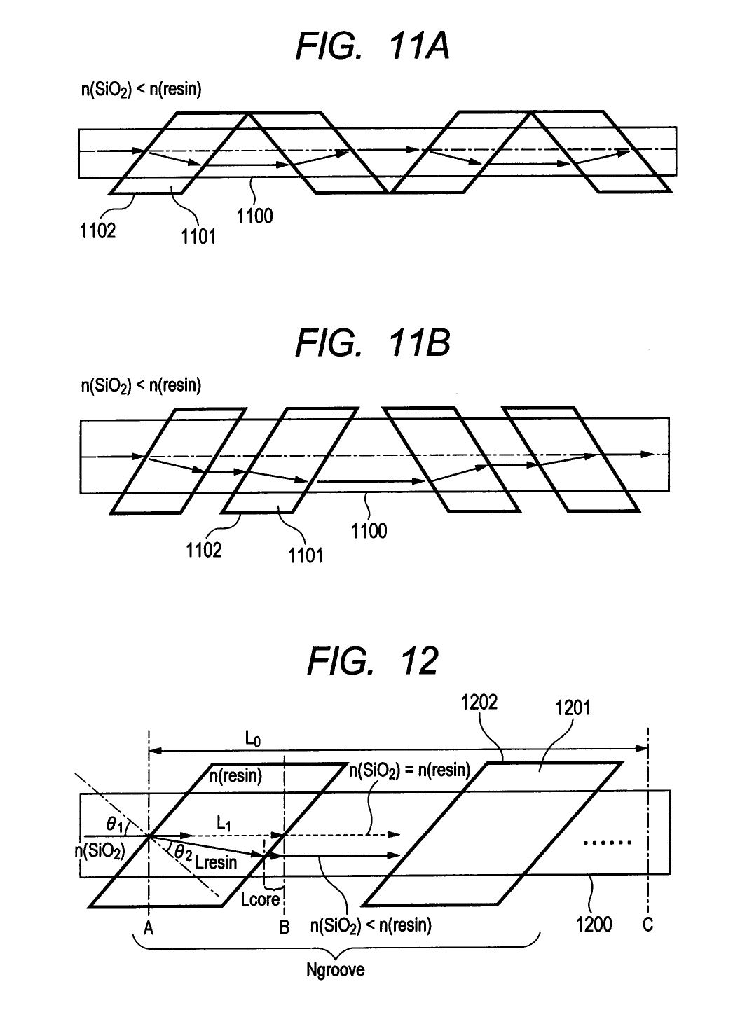

FIG. 11A and FIG. 11B show schematic views of the waveguide of the wavelength division multiplexer according to the fifth embodiment of the present invention. FIG. 11A and FIG. 11B illustrate a waveguide 1100, a temperature compensation resin 1101, and a groove 1102. The wavelength division multiplexer according to the present embodiment is almost the same as the wavelength division multiplexer according to the above-described one embodiment, but a different point is that the intersection angle of adjacent each groove was reversed alternately (FIG. 11A), or every certain number (FIG. 11B).

Since the shift direction of the optical axis of propagation light due to reflection at each unit groove from the center of the waveguide is able to be reversed alternately, or by increments, there is provided an additional effect that an amount of shift of the optical axis in the waveguide of the formed groove section as a whole is able to be reduced.

### Sixth Embodiment

Further, FIG. 12 shows a schematic view of the optical waveguide circuit according to the sixth embodiment of the present invention. FIG. 12 illustrates a waveguide 1200, a temperature compensation resin 1201, and a groove 1202. The waveguide 1200 shown in FIG. 12 is almost the same configuration as the waveguide according to the above-described one embodiment, but its configuration is such that the plurality of unit grooves is incorporated in one waveguide. In the present embodiment, the optical path length nL in the single waveguide is designed to be constant. In addition, as with the above-described one embodiment, the present embodiment is directed to compensate the temperature dependence of the center wavelength of propagation light due to the refractive index change of the waveguide with changing temperature by forming the plurality of unit grooves in one waveguide at the intersection angle θ₁ and by filling the plurality of unit grooves with the temperature compensation resin.

That is, L₁ and N_{groove} are determined to satisfy the following formula at temperature region near the center of the operating temperature range.

$${L}_{0} \cdot \frac{d n ( {SiO}_{2} )}{d T} + {L}_{1} \cdot Ngroove \cdot [ \frac{d n ( resin )}{d T} - \frac{d n ( {SiO}_{2} )}{d T} ] = 0 \qquad ( Formula 11 )$$

Wherein, in FIG. 12, L₀ is the waveguide length between A and C, L₁ is the unit groove length, and N_{groove} is the number of unit grooves.

Next, in the case where the waveguide length between A and C is L₀, the unit groove length is L₁, the number of unit grooves is N_{groove} in FIG. 12, the distance Lᵣₑₛᵢₙ that the light passes through the resin and L_{core} that the light propagates in the core between A and B are represented by the formula (4) and (5) as with the first embodiment. Therefore, the optical path length nL between A and C is expressed as the following formula,

nL=n(SiO₂)·(L₀−L₁·Ngroove+Lcore·Ngroove)+n(re sin)·Lre sin·Ngroove (Formula 12)

and an optimum θ₁ can be obtained as with the above-described one embodiment by calculating the temperature change of nL with changing the intersection angle θ₁.

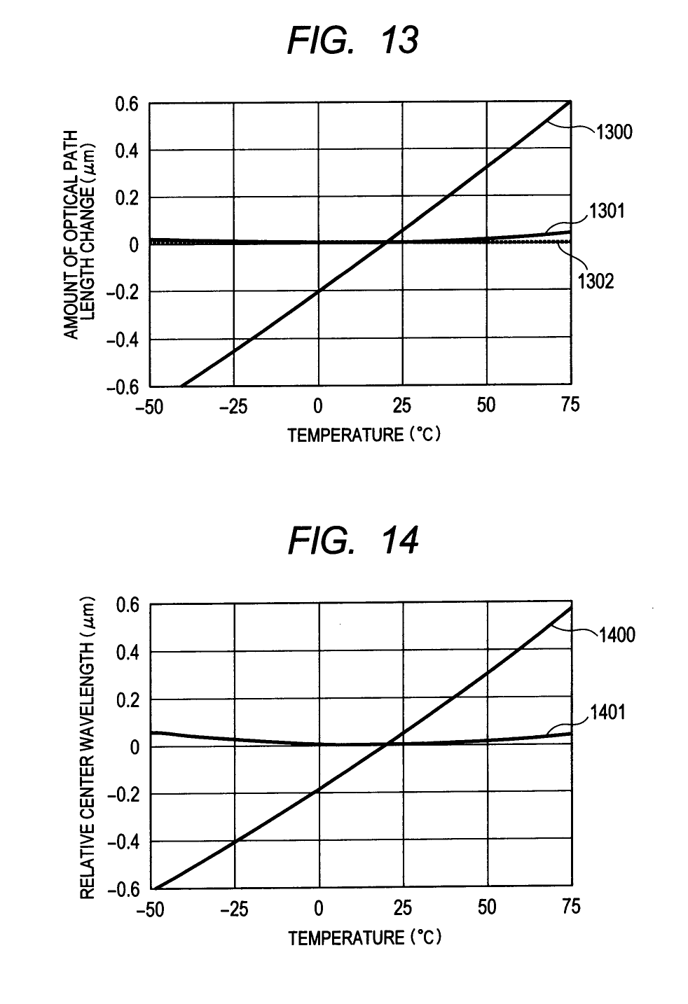

FIG. 13 shows the temperature change (reference numeral 1302) of the optical path length nL between A and C calculated by using parameters shown in Table 4.

TABLE 4
Optical waveguide circuit parameters for calculation of
temperature dependence according to the sixth embodiment

| Difference of waveguide | 1000 | μm |
|---|---|---|
| length between A and C L₀ | | |
| Temperature coefficient of | 1.9 × 10⁻⁸ T + 1.0 × 10⁻⁵ | |
| refractive index of | | |
| waveguide dn(SiO₂)/dT | | |
| Temperature coefficient of | −3.5 × 10⁻⁴ | |
| refractive index of | | |
| temperature compensation | | |
| material dn(resin)/dT | | |
| The number of unit grooves | 60 | |
| Unit groove length L₁ | 14 | μm |
| Intersection angle θ₁ | 68 | degrees |

The temperature change of nL without temperature compensation (reference numeral 1300), and with 0 degree intersection angle (reference numeral 1301) are illustrated in FIG. 13 by way of comparison. The optical path length nL can be become nearly constant by setting the intersection angle θ₁ at 68 degrees according to FIG. 13, and also the center wavelength λ_{c} becomes constant according to the formula (10).

The present invention is not to be limited to the examples of above-described embodiments, but is applicable to various optical waveguide circuits in which the compensation material having the temperature coefficient of refractive index different from the temperature coefficient of the refractive index of the waveguide is filled in the groove formed on a part of the waveguide. Also, the constitutional material and the compensation material of the waveguide are not limited to the examples of the embodiments, and various optically-transparent materials such as a semiconductor, a glass, a ceramic, a resin and the like are applicable as the constitutional and compensation materials, but a preferred combination of materials is that a loss is low and the refractive indices of the constitutional material of the waveguide and the compensation material are close and the temperature coefficients of refractive indices of both materials differ substantially, and it is further preferred that the temperature coefficients of reflective indies are opposite signs.

In the above examples of the present embodiments, the unit groove formed on each waveguide has the same width and intersects with each waveguide at the same angle, but is not limited to, and the groove may be formed for a temperature compensation groove by a combination of unit grooves, each having a different width and a different angle. In this case, it is only necessary to accumulate an amount of the optical path length change at each unit groove portion formed on each waveguide and to design the unit groove using the accumulation.

1. An optical waveguide circuit comprising:
a waveguide whose temperature coefficient of refractive index has a second-order component;
a groove formed in a part of the waveguide; and
a compensation material filled in the groove and having a temperature coefficient of refractive index different from the temperature coefficient of refractive index of the waveguide, wherein
a normal line of an interface between the groove and the waveguide, and an optical axis of light propagating through the waveguide intersect at a predetermined intersection angle; and
the predetermined intersection angle is determined so as to reduce a second-order component of optical path length change of the waveguide due to the second-order component of the temperature coefficient of the refractive index of the waveguide.

2. The optical waveguide circuit according to claim 1, wherein
the groove includes a plurality of unit grooves, and
the predetermined intersection angle is the same in all the unit grooves.

3. The optical waveguide circuit according to claim 1, wherein
the groove includes a plurality of unit grooves, and
the predetermined intersection angle forms a structure in which the intersection angle of each unit groove is reversed alternately or every certain number.

4. An optical waveguide circuit comprising:
a plurality of waveguides whose temperature coefficient of refractive index has a second-order component and whose lengths are different from one another;
a first groove formed in a first waveguide of the plurality of waveguides;
a second groove formed in a second waveguide of the plurality of waveguides; and
a compensation material filled in the first and second grooves and having a temperature coefficient of refractive index different from the temperature coefficient of refractive index of the waveguide, wherein
a normal line of an interface between the first groove and the first waveguide and an optical axis of light propagating through the first waveguide intersect at a first intersection angle; and
a normal line of an interface between the second groove and the second waveguide, and an optical axis of light propagating through the second waveguide intersect at a second intersection angle.

5. The optical waveguide circuit according to claim 4, wherein the first intersection angle and the second intersection angle differ from each other.

6. The optical waveguide circuit according to claim 5, wherein the first intersection angle is determined so as to reduce a second-order component of temperature change of an optical path length difference between the first and second waveguides due to the second-order component of the temperature coefficient of the refractive index of the first and second waveguides.

7. The optical waveguide circuit according to claim 4, wherein:
the grooves include a plurality of unit grooves;
the first intersection angle is the same in all the unit grooves; and
the second intersection angle is the same in all the unit grooves.

8. The optical waveguide circuit according to claim 4, wherein
the grooves include a plurality of unit grooves, and
the first intersection angle and/or the second intersection angle form a structure in which the intersection angle of each unit groove is reversed alternately or every certain number.

9. The optical waveguide circuit according to claim 4, wherein the optical waveguide circuit is an optical interferometer in which any one end of the plurality of waveguides having different lengths is connected by an optical coupler.

10. The optical waveguide circuit according to claim 9, wherein the optical waveguide circuit is a Mach-Zehnder interferometer in which both ends of the two waveguides having different lengths are connected by an optical coupler.

11. A Mach-Zehnder interferometer-synchronized arrayed waveguide grating-type optical interferometer comprising:
the Mach-Zehnder interferometer according to claim 10; and
an arrayed waveguide grating, wherein the Mach-Zehnder interferometer is connected to an input waveguide of the arrayed waveguide grating.

12. The optical waveguide circuit according to claim 1, wherein the optical waveguide circuit is a wavelength division multiplexer.

13. A method of manufacturing an optical waveguide circuit formed by a waveguide made of a material whose temperature coefficient of refractive index has a second-order component, the method comprising the steps of:
providing an optical waveguide circuit in which the waveguide is formed;
forming a groove in a part of the waveguide; and
filling the groove with a compensation material having a temperature coefficient of refractive index different from the temperature coefficient of refractive index of the waveguide, wherein
a normal line of an interface between the groove and the waveguide, and an optical axis of light propagating through the waveguide intersect at a predetermined intersection angle; and
the predetermined intersection angle is determined so as to reduce at least a second-order component of optical path length change of the waveguide due to the second-order component of the temperature coefficient of refractive index of the waveguide.

14. A method of manufacturing an optical waveguide circuit formed by a plurality of waveguides which is made of a material whose temperature coefficient of refractive index has a second-order component and which has lengths different from one another, the method comprising the steps of:
providing an optical waveguide circuit in which the plurality of waveguides is formed;
forming a first groove in a first waveguide of the plurality of waveguides and forming a second groove in a second waveguide of the plurality of waveguides; and
filling the first and second grooves with a compensation material having a temperature coefficient of refractive index different from the temperature coefficient of refractive index of the waveguide, wherein
a normal line of an interface between the first groove and the first waveguide, and an optical axis of light propagating through the first waveguide intersect at a first intersection angle, and
a normal line of an interface between the second groove and the second waveguide, and an optical axis of light propagating through the second waveguide intersect at a second intersection angle.

15. The method of manufacturing an optical waveguide circuit according to claim 14, wherein the first intersection angle and the second intersection angle differ from each other.

16. The method of manufacturing an optical waveguide circuit according to claim 14, wherein the first intersection angle is determined so as to reduce a second-order component of temperature change of an optical path length difference between the first and second waveguides due to the second-order component of the temperature coefficient of refractive index of the first and second waveguides.
